(19) United States
(12) Patent Application Publication
(10) Pub. No.: US 2018/0118971 A1
(43) Pub. Date: May 3, 2018

(54) AQUEOUS POLYURETHANE-POLYACRYLATE DISPERSIONS

(71) Applicant: Covestro Deutschland AG, Leverkusen (DE)

(72) Inventors: Pantea Nazaran, Köln (DE); Rolf Gertzmann, Leverkusen (DE); Tanja Hebestreit, Wipperfürth (DE)

(21) Appl. No.: 15/566,026

(22) PCT Filed: Apr. 12, 2016
(86) PCT No.: PCT/EP2016/058006

§ 371 Date: Oct. 12, 2017

(30) Foreign Application Priority Data
Apr. 13, 2015 (EP) 15163342.7

(51) Int. Cl. C09D 151/08; C08G 18/44; C08G 18/72; C08G 18/75; C08G 18/34; C08G 18/66; C08G 18/08; C08F 283/00

(52) U.S. Cl. CPC C09D 151/08; C08G 18/44; C08G 18/722; C08G 18/752; C08F 283/006; C08G 18/348; C08G 18/6659; C08G 18/0823; C08G 18/755

(57) ABSTRACT

The present invention relates to an aqueous polyurethane-polyacrylate dispersion, obtainable by radical polymerization of a component A), comprising an ethylenically unsaturated compound, at least in the presence of a component B), comprising water and a polyurethane resin, obtainable by reaction of the following synthesis components I), comprising at least one aliphatic, cycloaliphatic, araliphatic and/or aromatic compound having at least two or more isocyanate groups, II), comprising at least one polycarbonate polyol having an average molecular weight of 500 to 3000 g/mol, III), comprising at least one anionically hydrophilizing compound which has at least one OH- or NH-functional group and comprising a carboxyl and/or carboxylate group, IV), comprising at least one polyol and/or polyamine having an average molecular weight of between ≥62 and ≤500 g/mol, and optionally V), comprising at least one or more monoalcohols and/or monoamines, the radical polymerization being initiated using a hydrophilic initiator.

### CROSS REFERENCE TO RELATED APPLICATIONS

This application is a national stage application under 35 U.S.C. § 371 of PCT/EP2016/058006, filed Apr. 12, 2016 which claims benefit of European Application No. 15163342.7, filed Apr.13, 2015 and which are incorporated herein by reference.

### FIELD OF THE INVENTION

The invention relates to an aqueous polyurethane/polyacrylate dispersion and to a process for production thereof. The invention further provides a coating composition comprising the aqueous polyurethane/polyacrylate dispersion, and the use of this coating composition for production of a coating. The invention further relates to a composite composed of the coating and a substrate.

### BACKGROUND OF THE INVENTION

Aqueous polyurethane dispersions are suitable for production of a multitude of coatings and feature very good properties, for example abrasion resistance, flexibility or else toughness.

As well as the straight polyurethane dispersions, polyurethane polymer hybrid dispersions are also known, for example polyurethane/polyacrylate dispersions. Polyacrylate dispersions often have elevated hardness and stability to chemicals and weathering influences. Moreover, a combination of polyurethane and polyacrylate dispersions can even give synergistic effects.

In general, aforementioned hybrid dispersions may be chemically and/or physically associated with one another. In the case of this physical association, it is also possible to refer to a physical blend.

As an example of chemically associated hybrid dispersions, WO 2011/089154 A2 discloses a process for producing aqueous polyurethane/polyacrylate dispersions, in which the polyurethane contains ethylenically unsaturated groups which are reacted with ethylenically unsaturated monomers. Chemically associated polymers are obtained by the crosslinking reaction of the unsaturated groups.

The high complexity of the polymerization reaction is a drawback of abovementioned chemically associated hybrid dispersions. Moreover, the chemical association increases the molecular weight and viscosity of the products, which can likewise make the production more difficult. In addition, not all polyurethane backbones are compatible with the graft polymerization, and so the fields of use can be restricted here.

By contrast, the polymerization reaction in the case of a physical blend for production of the hybrid dispersions is much easier to control and is not afflicted with the drawbacks described above.

Polyurethane/polyacrylate hybrid systems in which the polyurethane and the polyacrylate do not enter into any chemical bond with one another but interact merely physically are disclosed, for example, in EP 1124871 B1. The polyurethane/polyacrylate hybrid dispersion described is produced by means of a pre-emulsified mixture of monomer and lipophilic (oil-soluble) initiator in the presence of a polyurethane.

Because of the lipophilic initiators, the free-radical polymerization in this method takes place in the monomer droplets. For particular polymer compositions, however, this production method is unsuitable, for example when very hydrophobic acrylate monomers that do not have adequate water solubility are used or when the monomer mixture and/or initiator solution are to be metered in so as to attain particular polymer morphologies, for example hybrid dispersions with a core-shell morphology of the polymer particles. In such cases, the dispersions produced by means of the method described in EP 1124871 B1 have inadequate stability or, because of the use of a lipophilic initiator, are not even producible in the absence of an additional emulsifier.

### DESCRIPTION OF THE FIGURE

FIG. 1 is a graph showing testing of ring line stability based on dispersions PUR-PAC 1 to PUR-PAC 4.

### DETAILED DESCRIPTION OF THE INVENTION

The aqueous polyurethane dispersions described at the outset are already being used, for example, for paint systems in the automotive sector. The avoidance of organic solvents makes it possible to comply with even stricter environmental regulations. In order to make the painting process more efficient, for example, it is possible to apply fewer paint coats or to reduce the thickness of the paint coats.

With these rises in efficiency, on the other hand, there is also an increase in the demands on the properties of the paint systems used and hence in particular on the aqueous dispersions used. Particularly important in this context are good hiding capacity, hardness, chemical and weathering resistance, and a good flip-flop effect. This gives rise to a possible use for hybrid dispersions, for example polyurethane/polyacrylate dispersions, since controlled modification with polyacrylates makes it possible to achieve the desired properties.

As well as the properties of the paints obtainable from the dispersions, maximum stability of the dispersion or of the binder with respect to shear forces on application or in pumping operations is very important. However, the prior art polyurethane/polyacrylate dispersions have only inadequate stability and cannot be formulated to give binders having the required properties.

It was therefore an object of the present invention to at least partly overcome at least one drawback of the prior art.

In addition, it was an object of the present invention to provide an aqueous polyurethane/polyacrylate dispersion which leads to binders having improved stability to shear forces compared to the polyurethane/polyacrylate dispersions known in the prior art and from which it is additionally possible to produce coatings having very good hiding power, hardness, chemical and weathering resistance and a good flip-flop effect.

It was a further object of the present invention to provide a very substantially solvent- and emulsifier-free aqueous polyurethane/polyacrylate dispersion having the same properties as described above.

This object is achieved in accordance with the invention by an aqueous polyurethane/polyacrylate dispersion obtainable by free-radical polymerization of a component A) comprising an ethylenically unsaturated compound, at least in the presence of a component B) comprising water and a polyurethane resin obtainable by reaction of the following formation components:
I), comprising at least one aliphatic, cycloaliphatic, araliphatic and/or aromatic compound having at least two or more isocyanate groups,
II), comprising at least one polycarbonate polyol having a mean molecular weight of 500 to 3000 g/mol,
III), comprising at least one anionically hydrophilizing compound which has at least one OH- or NH-functional group and contains a carboxyl and/or carboxylate group,
IV), comprising at least one polyol and/or polyamine having a mean molecular weight between ≥62 and ≤500 g/mol, and optionally
V), comprising at least one or more monoalcohols and/or monoamines,
   wherein a hydrophilic initiator is used as initiator of the free-radical polymerization.

In the present context, a hydrophilic initiator is understood to mean a chemical compound which has a high affinity for water, or high solvation tendency in water, and acts as a free-radical initiator.

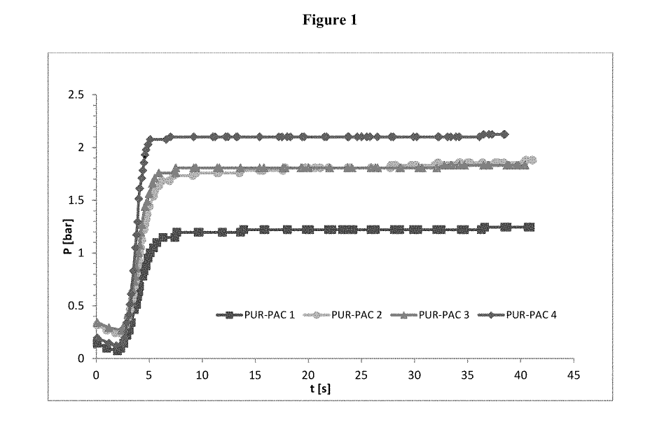

In the present context, the stability of the polyurethane/polyacrylate dispersions of the invention to shear forces is also referred to as ring line stability. Ring line stability can be simulated, for example, by means of a Göttfert capillary rheometer as described in K. Georgieva, D. J. Dijkstra, H. Fricke, N. Willenbacher, J. Colloid Interface Sci. 2010, 352, 265-277. FIG. 1 and table 1 on page 267 of K. Georgieva et al. show the apparatuses and technical specifications used for the present application. For the test, a particular amount of the binder to be examined is introduced into the vessel provided for the purpose and forced through an annular gap of gap size 20 μm at constant speed by means of a movable cylinder. The greater the shear stability of the binder, the smaller the pressure buildup as it is forced through the annular gap. In the case of shear-unstable material, the binder coagulates and blocks the nozzle, and a pressure buildup is recorded. The simulated shear forces can be calculated from the gap size and the speed.

In general, the mass ratio of components A) and B) can be chosen freely over a wide range. In a first preferred embodiment, component A) is used at 3% to 40% by weight, preferably at 5% to 30% by weight and more preferably at 7% to 25% by weight, and component B) at 97% to 60% by weight, preferably at 95% to 70% by weight and more preferably at 93% to 75% by weight, based on the total amount of the polyurethane/polyacrylate dispersion, where the ratios are normalized such that, even in the case of optional additional use of further components C), they cannot be greater than 100% and more preferably add up to 100%.

The polymerization is initiated with the hydrophilic initiators in common use for free-radical polymerization. These include water-soluble inorganic persulfates, for example ammonium persulfate or sodium persulfate.

In a further preferred embodiment, the hydrophilic initiator comprises one or more persulfate-containing compounds, preferably exclusively one or more persulfate-containing compounds and more preferably exclusively ammonium peroxodisulfate, sodium peroxodisulfate and/or potassium peroxodisulfate.

Component A)

In a further preferred embodiment, component A) comprises at least one aliphatic, cycloaliphatic or aromatic acrylate or methacrylate which is substituted or unsubstituted, preferably comprises at least one aliphatic or cycloaliphatic, optionally alkyl-substituted acrylate or methacrylate and more preferably comprises at least one mixture of an aliphatic, optionally alkyl-substituted acrylate and an aliphatic, optionally alkyl-substituted methacrylate.

Suitable ethylenically unsaturated compounds for component A) are one or more of the following compounds:
VI), styrene and/or other vinylaromatic compounds,
VII), acrylic esters,
VIII), polyvinylidene compound of functionality ≥2,
IX), methacrylic esters.

Vinylaromatic compounds VI), especially having up to 20 carbon atoms, are, for example, styrene, vinyltoluene, o- and p-methylstyrene, butylstyrene, decylstyrene, halogenated styrenes, for example monochlorostyrenes, dichlorostyrenes, tribromostyrenes or tetrabromostyrenes. Preference is given to styrene.

Suitable acrylic esters VII) especially include methyl acrylate, ethyl acrylate, propyl acrylate, isopropyl acrylate, n-butyl acrylate, sec-butyl acrylate, tert-butyl acrylate, pentyl acrylate, hexyl acrylate, heptyl acrylate, octyl acrylate, 2-octyl acrylate, ethylhexyl acrylate, nonyl acrylate, 2-methyloctyl acrylate, 2-(tert-butyl)heptyl acrylate, 3-(isopropyl)heptyl acrylate, decyl acrylate, undecyl acrylate, 5-methylundecyl acrylate, dodecyl acrylate, 2-methyldodecyl acrylate, tridecyl acrylate, 5-methyltridecyl acrylate, tetradecyl acrylate, pentadecyl acrylate, hexadecyl acrylate, 2-methylhexadecyl acrylate, heptadecyl acrylate, 5-(isopropyl)heptadecyl acrylate, 5-ethyloctadecyl acrylate, octadecyl acrylate, nonadecyl acrylate, eicosyl acrylate, cycloalkyl acrylates, for example cyclopentyl acrylate, cyclohexyl acrylate, 3-vinyl-2-butylcyclohexyl acrylate, cycloheptyl acrylate, cyclooctyl acrylate, bornyl acrylate, tetrahydrofurfuryl acrylate and isobornyl acrylate. Preference is given to ethyl acrylate, n-butyl acrylate, ethylhexyl acrylate, cyclohexyl acrylate, particular preference to ethylhexyl acrylate.

The suitable polyvinylidene compounds VIII) include those compounds that have at least two olefinically unsaturated bonds. These especially include acrylic or methacrylic esters of polyols of functionality ≥2, for example ethylene glycol diacrylate, diethylene glycol diacrylate, glycerol diacrylate, glycerol triacrylate, ethylene glycol dimethacrylate, propane-1,3-diol diacrylate, propane-1,3-diol dimethacrylate, butane-1,4-diol diacrylate, butane-1,4-diol dimethacrylate, hexane-1,6-diol diacrylate, hexane-1,6-diol dimethacrylate, butane-1,2,4-triol trimethacrylate, cyclohexane-1,4-diol diacrylate, benzene-1,4-diol dimethacrylate, pentaerythritol tri- and tetraacrylate or -methacrylate, dipentaerythritol hexaacrylate, tripentaerythritol hexaacrylate, tripentaerythritol octacrylate, trimethylolpropane triacrylate, trimethylolpropane trimethacrylate, trimethylolethane triacrylate, sorbitol hexaacrylate, propane-1,3-diol diacrylate, pentane-1,5-diol dimethacrylate, nonane-1,9-diol dimethacrylate, decane-1, 10-diol dimethacrylate, propylene glycol diacrylate, dipropylene glycol diacrylate, diacrylates and dimethacrylates of polyethylene glycol of molar mass 200 to 1500 g/mol. Preference is given to butane-1,4-diol diacrylate, trimethylolpropane dimethacrylate, ethylene glycol dimethacrylate, hexane-1,6-diol dimethacrylate, particular preference to ethylene glycol dimethacrylate or hexane-1,6-diol dimethacrylate.

Suitable esters IX) of methacrylic acid especially include methyl methacrylate, ethyl methacrylate, propyl methacrylate, isopropyl methacrylate, n-butyl methacrylate, sec-butyl methacrylate, tert-butyl methacrylate, pentyl methacrylate, hexyl methacrylate, heptyl methacrylate, octyl methacrylate, 2-octyl methacrylate, ethylhexyl methacrylate, nonyl methacrylate, 2-methyloctyl methacrylate, 2-(tert-butyl)heptyl methacrylate, 3-(isopropyl)heptyl methacrylate, decyl methacrylate, undecyl methacrylate, 5-methylundecyl methacrylate, dodecyl methacrylate, 2-methyldodecyl methacrylate, tridecyl methacrylate, 5-methyltridecyl methacrylate, tetradecyl methacrylate, pentadecyl methacrylate, hexadecyl methacrylate, 2-methylhexadecyl methacrylate, heptadecyl methacrylate, 5-(isopropyl)heptadecyl methacrylate, 5-ethyloctadecyl methacrylate, octadecyl methacrylate, nonadecyl methacrylate, eicosyl methacrylate, cycloalkyl methacrylates, for example cyclopentyl methacrylate, cyclohexyl methacrylate, 3-vinyl-2-butylcyclohexyl methacrylate, cycloheptyl methacrylate, cyclooctyl methacrylate, bornyl methacrylate, tetrahydrofurfuryl methacrylate or isobornyl methacrylate. In addition, the methacrylic acid derivatives may also be used in the form of the corresponding nitriles or amides, for example methacrylonitrile or methacrylamide. It is also possible to use other functional monomers depending on the desired application, for example diacetonemethacrylamide or acetoacetoxyethyl methacrylate. Preference is given to methyl methacrylate, ethyl methacrylate, butyl methacrylate, tert-butyl methacrylate, particular preference to methyl methacrylate, tert-butyl methacrylate or butyl methacrylate.

Polyurethane Resin of Component B)

Formation Component I):

Suitable aliphatic, cycloaliphatic, araliphatic and/or aromatic compounds having at least two or more isocyanate groups are, for example, di- or triisocyanates of the molecular weight range from 140 to 400. Preferred diisocyanates are 1,4-diisocyanatobutane, 1,5-diisocyanatopentane (PDI), 1,6-diisocyanatohexane (HDI), 1,5-diisocyanato-2,2-dimethylpentane, 2,2,4- or 2,4,4-trimethyl-1,6-diisocyanatohexane, 1,10-diiisocyanatodecane, 1,3- and 1,4-diisocyanatocyclohexane, 1,4-diisocyanato-3,3,5-trimethylcyclohexane, 1,3-diisocyanato-2-methylcyclohexane, 1,3-diisocyanato-4-methylcyclohexane, 1-isocyanato-3,3,5-trimethyl-5-isocyanatomethylcyclohexane (isophorone diisocyanate; IPDI), 1-isocyanato-1-methyl-4(3)-isocyanatomethylcyclohexane, 2,4′- and 4,4′-diisocyanatodicyclohexylmethane (H12-MDI), 1,3- and 1,4-bis(isocyanatomethyl)cyclohexane, 4,4′-diisocyanato-3,3′-dimethyldicyclohexylmethane, 4,4′-diisocyanato-3,3′, 5,5′-tetramethyldicyclohexylmethane, 4,4′-diisocyanato-1,1′-bi(cyclohexyl), 4,4′-diisocyanato-3,3′-dimethyl-1,1′-bi(cyclohexyl), 4,4′-diisocyanato-2,2′, 5,5′-tetramethyl-1,1′-bi(cyclohexyl), 1,8-diisocyanato-p-menthane, 1,3-diisocyanatoadamantane, 1,3-dimethyl-5,7-diisocyanatoadamantane, 1,3- and 1,4-bis(isocyanatomethyl)benzene (XDI), 1,3- and 1,4-bis(1-isocyanato-1-methylethyl)benzene (TMXDI), bis(4-(1-isocyanato-1-methylethyl)phenyl) carbonate, phenylene 1,3- and 1,4-diisocyanate, tolylene 2,4- and 2,6-diisocyanate (TDI) and any desired mixtures of these isomers, diphenylmethane 2,4′- and/or 4,4′-diisocyanate (MDI) and naphthylene 1,5-diisocyanate (NDI). Further diisocyanates that are likewise suitable can additionally be found, for example, in Justus Liebigs Annalen der Chemie, volume 562 (1949) p. 75-136.

In a further particularly preferred embodiment, the formation component I) comprises at least one aliphatic, cycloaliphatic, araliphatic and/or aromatic diisocyanate, preferably a mixture of aliphatic and/or cycloaliphatic diisocyanates and more preferably a mixture of 1,6-diisocyanatohexane, 1-isocyanato-3,3,5-trimethyl-5-isocyanatomethylcyclohexane and/or 4,4′-diisocyanatodicyclohexylmethane.

The above-specified diisocyanates can be prepared by known methods, for example by phosgenation or by a phosgene-free route, for example by urethane cleavage. It is thus also possible to use trifunctional and/or higher-functionality isocyanates in proportions of up to 5% by weight, based on the solid polyurethane resin, in order thus to give a certain degree of branching or crosslinking of the polyurethane. Isocyanates of this kind are obtained, for example, by reacting difunctional isocyanates with one another in such a way that a portion of the isocyanate groups thereof are derivatized to isocyanurate, biuret, allophanate, uretdione or carbodiimide groups. Also suitable are those polyisocyanates hydrophilized via ionic groups. Polyisocyanates of this kind can have high functionalities, for example of more than 3.

Formation Component II):

Formation component II) comprises at least one polycarbonate polyol having a mean molecular weight of 500 to 3000 g/mol. In a further preferred embodiment, the polycarbonate polyol has a mean molecular weight of 1000 to 3000 g/mol, preferably of 1250 to 2500 g/mol and more preferably of 1500 to 2100 g/mol. The mean molecular weight of the polycarbonate polyol can be determined by means of GPC (gel permeation chromatography) according to DIN 55672-1.

The selected polycarbonate polyols may have an OH functionality of 1.8 to 5, preferably of 1.9 to 3 and more preferably of 1.9 to 2.0, and can be prepared by known processes.

Suitable polycarbonates are obtainable, for example, by reaction of diphenyl carbonate, dimethyl carbonate or phosgene with polyols, preferably diols. Diols used here may, for example, be ethylene glycol, propane-1,2- and -1,3-diol, butane-1,3- and -1,4-diol, hexane-1,6-diol, octane-1,8-diol, neopentyl glycol, 1,4-bishydroxymethylcyclohexane, 2-methylpropane-1,3-diol, 2,2,4-trimethylpentane-1,3-diol, dipropylene glycol, polypropylene glycol, dibutylene glycol, polybutylene glycol, bisphenol A, tetrabromobisphenol A, but also lactone-modified diols. It is preferable when the diol component contains 40% to 100% by weight of hexanediol, preferably hexane-1,6-diol and/or hexanediol derivatives, more preferably those having not only terminal OH groups but also ether or ester groups, for example products which have been obtained by reaction of 1 mol of hexane-1,6-diol with at least 1 mol, preferably 1 to 2 mol, of caprolactone, or by etherification of hexane-1,6-diol with itself to give di- or trihexylene glycol.

It is also possible to use the polyether polycarbonate diols described in DE-A 37 17 060. The polycarbonate polyols are preferably of linear structure. However, they may optionally be lightly branched by the incorporation of polyfunctional components, especially low molecular weight polyols. Suitable examples for this purpose are glycerol, trimethylolpropane, hexane-1,2,6-triol, butane-1,2,4-triol, trimethylolethane, pentaerythritol, chinit, mannitol, sorbitol, methyl glycoside or 1,3:4,6-dianhydrohexitols.

As well as the polycarbonate polyols that are essential to the invention, it is also possible to use, for example, polyesters, polyethers, polyacetals, polyolefins, polyacrylates and polysiloxanes. Preference is given here to using polyesters and/or polyethers as further polyol component.

Preference is given here to using, aside from the polycarbonate polyols that are essential to the invention, a small amount, if any, of further polyol components as described above. Preferably, component B) includes the further polyol component to an extent of less than 10% by weight, or preferably to an extent of less than 5% by weight, or preferably to an extent of less than 3% by weight, or preferably to an extent of less than 1% by weight, or preferably within a range from 0.001% to 10% by weight, or preferably within a range from 0.001% to 5% by weight, or preferably within a range from 0.002% to 3% by weight, or preferably within a range from 0.003% to 1% by weight, based in each case on the total amount of component B). Preferably, component B) includes polyester polyol and/or polyether polyol as further polyol component to an extent of less than 10% by weight, or preferably to an extent of less than 5% by weight, or preferably to an extent of less than 3% by weight, or preferably to an extent of less than 1% by weight, or preferably within a range from 0% to 10% by weight, or preferably within a range from 0.001% to 5% by weight, or preferably within a range from 0.002% to 3% by weight, or preferably within a range from 0.003% to 1% by weight, based in each case on the total amount of component B). Preferably, formation component I) does not include any polyether polyol and/or polyester polyol. Preferably, component B) does not include any polyether polyol and/or polyester polyol.

Formation Component III):

Formation component III) comprises at least one anionically hydrophilizing compound which has at least one OH- or NH-functional group and contains a carboxyl and/or carboxylate group. In a further preferred embodiment, the anionically hydrophilizing compound is free of sulfonic acid groups and sulfonate groups, preferably comprises dimethylolpropionic acid, dimethylolpropionate, N-(2-aminoethyl)-2-aminoethanecarboxylic acid and/or N-(2-aminoethyl)-2-aminoethanoate, and more preferably consists of dimethylolpropionic acid, dimethylolpropionate, N-(2-aminoethyl)-2-aminoethanecarboxylic acid and/or N-(2-aminoethyl)-2-aminoethanoate.

Formation Component IV):

Formation component IV) comprises at least one polyol and/or polyamine having a mean molecular weight between ≥62 and ≤500 g/mol, preferably between ≥62 to ≤400 g/mol and more preferably between ≥90 to ≤300 g/mol. The following compounds, for example, are suitable here: ethanediol, propane-1,2- and -1,3-diol, butane-1,2-, -1,3- and - 1,4-diol, pentane-1,5-diol, 3-methylpentane- 1,5-diol, hexane-1,6-diol, neopentyl glycol, cyclohexane-1,4-dimethanol, cyclohexane-1,2-and -1,4-diol, 2-ethyl-3-propylpentanediol, 2,4-dimethylpentanediol, 2-ethyl-2-butylpropanediol, diethylenetriamine, ethylenediamine, ether oxygen-containing diols, for example diethylene glycol, triethylene glycol, tetraethylene glycol, dipropylene glycol, tripropylene glycol, polyethylene glycols, polypropylene glycols or polybutylene glycols, N-substituted ethanolamines and mixtures of these products. Preferred polyols are butane-1,4-diol, pentane-1,5-diol, 3-methylpentane-1,5-diol, hexane-1,6-diol, neopentyl glycol, cyclohexane-1,4-dimethanol, cyclohexane-1,2- and -1,4-diol and N-substituted ethanolamines. Very particularly preferred polyols and/or polyamines are butane-1,4-diol, hexane-1,6-diol, neopentyl glycol, diethylenetriamine, ethylenediamine, and N-substituted ethanolamines.

Trifunctional and higher-functionality alcohols of the molecular weight range specified can be used in such a proportion that the polymer solution remains stirrable. Such components include, for example, trimethylolpropane, glycerol and pentaerythritol.

Formation Component V):

Any formation component V) used comprises at least one or more than one monoalcohol and/or monoamine. In general, these compounds may have 1 to 18 carbon atoms. Suitable monoalcohols or monoamines are, for example, ethanol, 1-propanol, 2-propanol, primary butanol, secondary butanol, n-hexanol and isomers thereof, 2-ethylhexyl alcohol, ethylene glycol monomethyl ether, diethylene glycol monomethyl ether, ethylene glycol monobutyl ether, diethylene glycol monobutyl ether, propylene glycol monomethyl ether, dipropylene glycol monomethyl ether, tripropylene glycol monomethyl ether, dipropylene glycol monopropyl ether, propylene glycol monobutyl ether, dipropylene glycol monobutyl ether, tripropylene glycol monobutyl ether, 1-octanol, 1-dodecanol, 1-hexadecanol, lauryl alcohol and stearyl alcohol, and also butylamine, propylamine, aminoethanol, aminopropanol, diethanolamine or dibutylamine Preference is given to using ethanol, n-butanol, ethylene glycol monobutyl ether, 2-ethylhexanol, 1-octanol, 1-dodecanol, 1-hexadecanol, butylamine, propylamine, aminoethanol, dimethylethanolamine, aminopropanol, diethanolamine or dibutylamine Particular preference is given here to n-butanol and ethylene glycol monobutyl ether.

Preparation of Component B)

Component B) comprises a polyurethane resin and water. The polyurethane resin is obtainable by a process in which the formation components II), III), IV) and optionally V) are converted separately and in any sequence or as a mixture with formation component I), and formation component III), before, during or after the conversion of the polyurethane resin which is preferably in dissolved form in a suitable solvent to an extent of 99% to 65% by weight, more preferably 95% to 70% by weight and most preferably 90% to 80% by weight, is neutralized and the polyurethane resin is dispersed in water. Ideally, formation component V) is added only when the reactivity toward isocyanate groups is moderate and hence there is no gelation of the mixture. It is possible here for either formation component I) or one or more of components II)-V) to be initially charged. Preferably, component I) is initially charged, and components II)-V) are metered in and reacted with component I).

Preferably, component B), after the conversion of formation components I) to V), does not have any aliphatic C-C double bonds.

Generally, formation components I) to V) for production of the polyurethane resin can be used in any desired ratios. However, it is preferable here that the formation components I) to V) are used in ratios of
10% to 45% by weight, preferably 20% to 35% by weight, of formation component I),
45% to 75% by weight, preferably 55% to 70% by weight, of formation component II),
0.1% to 15% by weight, preferably 3% to 10% by weight, of formation component III),
0.1% to 5% by weight, preferably 0.5% to 3% by weight, of formation component IV) and
0% to 5% by weight, preferably 0% to 3% by weight, of formation component V),
   based on the total solids content of the polyurethane resin, and the ratios are chosen such that they cannot be greater than 100% and more preferably add up to 100%.

Solvents used are volatile components having boiling points below 100° C. that are removed from the dispersion by distillation at a later stage. Examples of suitable solvents include acetone, methyl ethyl ketone, tetrahydrofuran and tert-butyl methyl ether, preference being given to acetone.

“Solvent-free” in the context of the present application means that maximum amounts of solvent of ≤0.9% by weight, preferably ≤0.5% by weight and more preferably ≤0.3% by weight can remain in the dispersion.

Suitable neutralizing agents are alkaline organic and/or alkaline inorganic compounds. As well as aqueous ammonia and ethylamine and dimethylamine solution, preference is given to volatile primary, secondary and tertiary amines, for example dimethylethanolamine, morpholine, N-methylmorpholine, piperidine, diethanolamine, triethanolamine, diisopropylamine, 2-amino-2-methylpropanol and 2-N,N-dimethylamino-2-methylpropanol or mixtures of these compounds. Particular preference is given to tertiary amines that are unreactive toward isocyanates, for example triethylamine, diisopropylethylamine and N-methylmorpholine and mixtures of these tertiary amines, which are preferably added to the prepolymer prior to the dispersion.

According to the degree of neutralization, the dispersion can be adjusted to a very fine dispersion, such that it has the appearance virtually of a solution. The solids content of the dispersion obtained after distillation of the solvent can also be varied within wide limits, for example from 20% to 65% by weight. A preferred solids range extends here from 30% to 50% by weight, and particular preference is given to a solids content of 33% to 45% by weight.

Excess isocyanate groups are subsequently reacted with formation component IV) in the aqueous phase.

As well as the water which has been used for dispersion of the polyurethane resin, component B) may also comprise further water.

Optional Component C)

As well as components A) and B) that are essential to the invention and the hydrophilic initiator, the polyurethane/polyacrylate dispersion of the invention, in a further preferred embodiment, may also comprise an optional component C). The optional component C) may, for example, comprise further polymers such as polyacrylate dispersions or polyurethane dispersions.

Preferably, the polyurethane/polyacrylate dispersion does not include any further component C) aside from components A) and B).

In a preferred embodiment of the aqueous polyurethane/polyacrylate dispersion, the following formation components consist
I), of at least one aliphatic, cycloaliphatic, araliphatic and/or aromatic compound having at least two or more isocyanate groups,
II), of at least one polycarbonate polyol having a mean molecular weight of 500 to 3000 g/mol,
III), of at least one anionically hydrophilizing compound which has at least one OH- or NH-functional group and contains a carboxyl and/or carboxylate group,
IV), of at least one polyol and/or polyamine having a mean molecular weight between ≥62 and ≤500 g/mol.

In a preferred embodiment of the aqueous polyurethane/polyacrylate dispersion, component B) comprises a polyester polyol and/or a polyether polyol as further polyol component together in an amount of less than 10% by weight, preferably of less than 5% by weight or preferably of less than 3% by weight, based on the total weight of component B).

Production of the Aqueous Polyurethane/Polyacrylate Dispersion of the Invention

The present invention further provides a process for producing the aqueous polyurethane/polyacrylate dispersion of the invention. In this process, the free-radical polymerization of component A) is conducted in the presence at least of the hydrophilic initiator and of component B). Preferably, no other initiator apart from a hydrophilic initiator is used.

In the process of the invention, it is preferable when component B) is initially charged and the free-radical polymerization is conducted by continuous metered addition of component A) in the presence at least of the hydrophilic initiator which is preferably likewise metered continuously into the initial charge of component B) in parallel with the metered addition of component A). The metered addition can be effected in portions or continuously, preference being given here to continuous metered addition. The continuous metered addition can be effected over any desired period of time, which can be chosen according to the amounts to be used. The choice of the appropriate period of time can also be used to control the morphology of the polyurethane/polyacrylate dispersion of the invention, since the polyacrylate oligomers that form become oriented in the polyurethane particles and hence the structure of the core-shell morphology can be influenced.

Optionally, in addition to the water which has been used for dispersion of the polyurethane, even further solvent, preference being given here to water, may be added to component B) before the reaction with component A) is effected.

As already described above, the hydrophilic initiator, in a further preferred embodiment of the process of the invention, in parallel with the continuous metered addition of component A) to component B), is likewise metered continuously into component B). Generally, the hydrophilic initiator can be added in substance or dissolved in a suitable solvent. It is preferable here when the initiator is metered in dissolved in a solvent. Most preferably, water is used here as solvent. In general, the initiator concentration can be chosen freely over a wide range, but the concentration of the hydrophilic initiator in the solvent chosen is preferably within a range from ≥0.001% to ≤5% by weight, preferably from ≥0.01% to ≤3% by weight and more preferably from ≥0.1% to ≤2% by weight.

In principle, it is possible that component A) can be metered in in one step in its total amount for use or in two or more portions. However, it has been found to be particularly preferable when a portion of component A) is metered into component B) in parallel with a portion of the optionally dissolved hydrophilic initiator in a first step and the mixture obtained is then stirred for up to 5 hours, preferably up to 3 hours and more preferably up to one hour before the rest of component A) is metered into the stirred mixture in parallel with the residual optionally dissolved hydrophilic initiator. The addition within the portions is preferably effected continuously.

On completion of addition of component A) and of the hydrophilic initiator, the mixture obtained can be stirred for a certain further period, preferably up to 5 hours and more preferably up to 3 hours.

The free-radical polymerization of component A) in the presence at least of the hydrophilic initiator and component B) can preferably be conducted at temperatures between ≥30° C. and ≤95° C. It is unimportant here whether component B) is heated before or during the addition of component A) and the initiator. It is particularly preferable, however, when the temperature is between ≥40° C. and ≤90° C. This gives rise to the advantage that the reaction rate can be increased without the risk of destabilization of the polyurethane dispersion.

In a further preferred embodiment of the process of the invention, the free-radical polymerization of component A) is effected in the presence of a hydrophilic initiator and component B) in the absence of additional emulsifiers.

If necessary, the polyurethane/polyacrylate dispersion of the invention obtained can also be filtered.

In a further preferred embodiment, the polyurethane/polyacrylate dispersion of the invention has a solids content of 20% to 70% by weight, preferably of 30% to 60% by weight and more preferably of 40% to 50% by weight. More preferably, the polyurethane/polyacrylate dispersion is solvent-free for the purposes of the present invention.

The aqueous polyurethane/polyacrylate dispersion of the invention is suitable for a multitude of uses, for example as a binder component in a coating composition. By virtue of the very small proportion of any solvents other than water that are present, the dispersion of the invention has particularly advantageous environmental properties.

The invention therefore further provides coating compositions comprising at least one polyurethane/polyacrylate dispersion of the invention and at least one crosslinking agent and optionally further auxiliaries and additives.

Examples of suitable crosslinking agents include amide- and amine-formaldehyde resins, phenolic resins, aldehyde and ketone resins, e.g. phenol-formaldehyde resins, resols, furan resins, urea resins, carbamic ester resins, triazine resins, melamine resins, benzoguanamine resins, cyanamide resins, aniline resins, water-thinnable or water-dispersible melamine- or urea-formaldehyde condensation products. Preference is given to using amino crosslinker resins.

Likewise suitable crosslinking agents may also be blocked polyisocyanates, for example based on hexamethylene 1,6-diisocyanate, bis(4-isocyanatocyclohexane)methane, 1,3-diisocyanatobenzene, tetramethylene diisocyanate, methylpentamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanatodicyclohexylpropane-(2,2), 1,4-diisocyanatobenzene, 1-methyl-2,4(2,6)-diisocyanatocyclohexane, 2,4-diisocyanatotoluene, 2,6-diisocyanatotoluene, 4,4′-diisocyanatodiphenylmethane, 2,2′- and 2,4′-diisocyanatodiphenylmethane, p-xylylene diisocyanate, p-isopropylidene diisocyanate, 4-isocyanatomethyl-1,8-octane diisocyanate, p-xylylene diisocyanate and α,α,α′,α′-tetramethyl-m- or -p-xylylene diisocyanate and mixtures consisting of these.

It will be appreciated that it is also possible, on the basis of the polyisocyanates mentioned by way of example, to use the higher-functionality polyisocyanates having uretdione groups and/or carbodiimide groups and/or allophanate groups and/or isocyanurate groups and/or urethane groups and/or iminooxadiazinedione groups and/or oxadiazinetrione groups and/or biuret groups that are known per se in polyurethane chemistry as blocked crosslinking agents.

It is also possible to use mixtures of various diisocyanates and/or polyisocyanates.

Suitable blocking agents for the aforementioned polyisocyanates may be monoalcohols, for example methanol, ethanol, butanol, hexanol, benzyl alcohol, oximes, for example acetoxime, methyl ethyl ketoxime, lactams, for example caprolactam, phenols, CH-acidic compounds, for example acetoacetic esters or malonic esters, for example diethyl malonate, dimethylpyrazole, amines, for example tert-butylbenzylamine, triazole, dimethyltriazole, dicyclohexylamine or diisopropylamine.

Any auxiliaries and additives present may, for example, be the following that are known to those skilled in the art: cobinders, desiccants, fillers, cosolvents, color or effect pigments, leveling aids, thickeners or flatting agents. Auxiliaries and additives used may optionally also be compounds that bear groups reactive toward the crosslinking agent.

The coating compositions of the invention can be used very efficiently in order to produce a coating on a substrate. The invention therefore further provides for such a use.

Application of the coating composition of the invention can be effected by known methods, for example by spraying, painting, flow coating or with the aid of rollers or coating bars onto any desired substrates. It is particularly on application that the high stability of the coating composition to shear forces by virtue of the inventive aqueous polyurethane/polyacrylate dispersion is manifested.

Examples of suitable substrates include metal, wood, glass, stone, ceramic materials, concrete, plastics, composites, textiles, leather or paper, which may optionally also be provided with customary primers prior to coating. Particularly preferred substrates are substrates having a surface of metal and/or plastic, including in the form of foils/films.

The drying conditions to be employed in each case may be matched to the crosslinking agent used and any auxiliaries and additives used.

After the coating composition of the invention has been dried on the substrate, a coating characterized by very good mechanical and optical properties is obtained. In addition, the coatings of the invention are notable for high hiding power.

The invention therefore further provides a coating obtainable through use of the coating composition of the invention.

As well as the coating itself, the invention further provides a composite composed of a coating of the invention and a substrate having a surface of metal and/or plastic.

The invention is elucidated in detail hereinafter by examples.

### EXAMPLES

Unless indicated otherwise, all percentages are based on weight.

Unless stated otherwise, all analytical measurements relate to temperatures of 23° C.

The solids contents (nonvolatile component) were determined to DIN-EN ISO 3251.

Unless explicitly mentioned otherwise, NCO contents were determined by volumetric means to DIN-EN ISO 11909.

The check for free NCO groups was conducted by means of IR spectroscopy (band at 2260 cm⁻¹).

The viscosities reported were determined by means of rotary viscometry to DIN 53019 at 23° C. with a rotary viscometer from Anton Paar Germany GmbH, Ostfildern, DE.

Median particle sizes were determined by means of laser correlation spectroscopy (LCS) with a Malvern Zetasizer 1000 spectrometer from Malvern Instruments Ltd., with given Z-average values.

The number-average molecular weight was determined by gel permeation chromatography (GPC) in tetrahydrofuran at 23° C. The procedure is according to DIN 55672-1: “Gel permeation chromatography, Part 1 —Tetrahydrofuran as eluent” (SECurity GPC System from PSS Polymer Service, flow rate 1.0 ml/min; columns: 2×PSS SDV linear M, 8×300 mm, 5 μm; RID detector). Polystyrene samples of known molar mass are used for calibration. The number-average molecular weight is calculated with software support. Baseline points and evaluation limits are fixed in accordance with DIN 55672 Part 1.

Assessment of the Paint Film

Pour-On Test

The binder mixture was poured over a cleaned glass plate that was stored in a vertical/slightly inclined position at room temperature for 2 hours. This was followed by a visual inspection against a light source and a dark background in order to assess inclusions (e.g. specks, gel particles, blisters) or faults (e.g. turbidity, cracking, leveling faults) in the paint film.

By comparison of the paint film with the blistering images of DIN EN ISO 4628-2, an inspection is made according to the amount and size of the craters and specks.

| Code letter | |
|---|---|
| and index | Definition |
| m 0 | no damage |
| m 1 | fewer blisters or craters than the amount corresponding |
| | to index 2 (about ⅓) |
| m 2 to m 5 | corresponding to the blistering/cratering images |
| | (analogous to the blistering images of DIN EN ISO 4628-2) |
| g 0 | no damage |
| g 1 | blisters/craters still just visible by the naked eye |
| | (limit of the visible range) |
| g 2 to g 5 | corresponding to the blistering/cratering images |
| | (analogous to the blistering images of DIN EN ISO 4628-2) |

Clearcoat Test

For the clearcoat test, the coating materials were applied to a glass plate and dried at 140° C. in a laboratory drying cabinet for 20 minutes.

Film assessment: The film assessment on the baked clearcoat film was made analogously to the film assessment in the pour-on test. (OK/partly OK/not OK)

Pendulum damping: Pendulum damping was measured according to DIN EN ISO 1522 and was determined according to König.

Solvent resistance: For this purpose, a small amount of the relevant solvents (xylene, 1-methoxyprop-2-yl acetate, ethyl acetate or acetone (abbreviated in table 6 to: X1/MPA/EA/acetone)) was placed in a test tube and a cotton pad was placed at the opening, so that an atmosphere saturated with solvent formed within the test tube. The test tubes were then applied to the paint surface by the cotton pad and remained there for 1 minute. After the solvent had been wiped off, the film was checked for destruction/softening/loss of adhesion. (0 =no change, 5 =film destroyed)

Yellowing: Yellowing was determined with a multiangle spectrophotometer in reflection mode against a white tile. The measured values Δ b* were determined according to DIN EN ISO 11664.

Basecoat Test

The basecoat tests were effected in a complete setup. For this purpose, prior to application of the clearcoat, the plate material was coated with a one-component OEM primer-surfacer. The primer-surfacer was baked at 165° C. for 20 minutes. Then the basecoat was applied by means of a gravity-fed cup gun and flashed off/predried at 80° C. for 10 minutes. Subsequently, a two-component PUR OEM clearcoat was applied and baked at 140° C. for 30 minutes.

Appearance: The appearance was visually assessed. Edge thinning describes the contraction of the paint at the edges of the substrate; floating describes poor alignment/orientation of effect pigments.

Flip-flop effect: The flip-flop effect was determined with a multiangle spectrophotometer according to DIN 6175-2.

Hiding power: For hiding power, the basecoat was coated onto a white/black test chart and visually assessed.

Substances and Abbreviations Used

Desmodur® W: 4,4′-diisocyanatodicyclohexylmethane, trans-trans content about 20% by weight, Bayer MaterialScience AG, Leverkusen, Germany

Desmodur® I: 1-isocyanato-3,3,5-trimethyl-5-isocyanatomethylcyclohexane, Bayer MaterialScience AG, Leverkusen, Germany

Desmophen® C 1200: polycarbonate ester (hexane-1,6-diol, -caprolactone), functionality =2, mean molecular weight =2000 g/mol, Bayer MaterialScience AG, Leverkusen, Germany

Polyester polyol I: polyester polyol formed from adipic acid and hexanediol, mean molecular weight =1700 g/mol

Methyl methacrylate (MMA): CAS 80-62-6, Sigma-Aldrich, Germany

2-Ethylhexyl acrylate (EHA): CAS 103-11-7, Sigma-Aldrich, Germany

Ammonium persulfate (APS): CAS 7727-54-0, Sigma-Aldrich, Germany

Tanemul 951: emulsifier (Tanatex, Germany)

Butyldiglycol: 2-(2-butoxyethoxy)ethanol (BDGL): CAS 112-34-5, cosolvent (Sigma-Aldrich, Germany)

Byk 346: polyether-modified siloxane, additive for reducing surface tension for improvement of substrate wetting (Byk Chemie GmbH, Germany)

Luwipal 073: melamine resin dissolved in water (BASF, Germany)

DMEA: N,N-dimethylethanolamine, neutralizing agent (Sigma-Aldrich, Germany)

Butylglycol: 2-butoxyethanol (BG): CAS 111-76-2, cosolvent (Sigma-Aldrich, Germany)

Aquatix 8421: rheology-modifying wax emulsion (Byk, Germany)

Setaqua D E 270: water-thinnable polyester (Nuplex, Germany)

Additol XL 250: wetting and dispersing additive (Allnex, Belgium)

Stapa Hydrolan 2156 Nr. 55900/G Aluminium: aluminum pigment paste (Eckart, Germany)

Further chemicals, unless stated otherwise, from Sigma-Aldrich Chemie GmbH, Taufkirchen, Germany. The raw materials, unless stated otherwise, were used without further purification or pretreatment.

### Example 1

### Production of the Polyurethaneurea Dispersion as Precursor PUR 1 (Inventive)

A mixture of 308 g of Desmophen® C 1200, 25 g of dimethylolpropionic acid, 10 g of neopentyl glycol, 1 g of butylglycol and 161 g of acetone was heated to 55° C. and stirred. Then 41 g of Desmodur® W and 93 g of Desmodur® I were added and the mixture was heated to 65° C. The mixture was stirred at this temperature until an NCO content of 1.8% had been attained. Thereafter, the mixture was cooled down to 60° C. and 12 g of dimethylethanolamine were added. 648 g of this solution were dispersed with vigorous stirring in 812 g of water that had been initially charged at a temperature of 35° C. Dispersion was followed by stirring for a further 5 min. Subsequently, within 10 min, a solution of 3 g of diethylenetriamine and 2 g of ethylenediamine and 1 g of butylamine in 73 g of water was added. On completion of addition, the mixture was stirred at 40° C. for 20 min before the acetone was removed by distillation under reduced pressure at this temperature. For reaction of the isocyanate groups to completion, the mixture was stirred at 40° C. until no NCO was detectable any longer by IR spectroscopy. After the mixture had been cooled down to <30° C., it was filtered through a 240 μm high-speed filter from Erich Drehkopf.
Indices of the polyurethane dispersion:
Mean particle size: 54 nm
pH (10% solid content, 20° C.): 8.2
Solids content: 35%
Viscosity (D 40 S⁻¹): 100 mPas

### Example 2

### Production of the Polyurethaneurea Dispersion as Precursor PUR 2 (Comparative)

A mixture of 202 g of Desmophen® C 1200, 172 g of polyester polyol I, 29 g of dimethylolpropionic acid, 8 g of neopentyl glycol, 1 g of butylglycol and 188 g of acetone was heated to 55° C. and stirred. Then 46 g of Desmodur® W and 106 g of Desmodur® I were added and the mixture was heated to 65° C. The mixture was stirred at this temperature until an NCO content of 1.7% had been attained. Thereafter, the mixture was cooled down to 60° C. and 14 g of dimethylethanolamine were added. 600 g of this solution were dispersed with vigorous stirring in 752 g of water that had been initially charged at a temperature of 35° C. Dispersion was followed by stirring for a further 5 min Subsequently, within 10 min, a solution of 3 g of diethylenetriamine and 2 g of ethylenediamine and 1 g of butylamine in 67 g of water was added. On completion of addition, the mixture was stirred at 40° C. for 20 min before the acetone was removed by distillation under reduced pressure at this temperature. For reaction of the isocyanate groups to completion, the mixture was stirred at 40° C. until no NCO was detectable any longer by IR spectroscopy. After the mixture had been cooled down to <30° C., it was filtered through a 240 μm high-speed filter from Erich Drehkopf.
Indices of the polyurethane dispersion:
Mean particle size: 69 nm
pH (10% humidity, 20° C.): 7.8
Solids content: 35%
Viscosity (D 40 S⁻¹): 120 mPas

### Example 3

### Production of the Polyurethaneurea Dispersion as Precursor PUR 3 (Comparative)

A mixture of 344 g of polyester polyol I, 29 g of dimethylolpropionic acid, 8 g of neopentyl glycol, 1 g of butylglycol and 178 g of acetone was heated to 55° C. and stirred. Then 46 g of Desmodur® W and 106 g of Desmodur® I were added and the mixture was heated to 65° C. The mixture was stirred at this temperature until an NCO content of 1.8% had been attained. Thereafter, the mixture was cooled down to 60° C. and 14 g of dimethylethanolamine were added. 600 g of this solution were dispersed with vigorous stirring in 751 g of water that had been initially charged at a temperature of 35° C. Dispersion was followed by stirring for a further 5 min Subsequently, within 10 min, a solution of 3 g of diethylenetriamine and 2 g of ethylenediamine and 1 g of butylamine in 67 g of water was added. On completion of addition, the mixture was stirred at 40° C. for 20 min before the acetone was removed by distillation under reduced pressure at this temperature. For reaction of the isocyanate groups to completion, the mixture was stirred at 40° C. until no NCO was detectable any longer by IR spectroscopy. After the mixture had been cooled down to <30° C., it was filtered through a 240 μm high-speed filter from Erich Drehkopf.
Indices of the polyurethane dispersion:
Mean particle size: 40 nm
pH (10% humidity, 20° C.): 7.4
Solids content: 35%
Viscosity (D 40 S⁻¹): 135 mPas

### Example 4

### Production of the Polyurethaneurea Dispersion as Precursor PUR 4 (Comparative)

A mixture of 376 g of Desmophen® C 1200, 29 g of neopentyl glycol, 1 g of butylglycol and 190 g of acetone was heated to 55° C. and stirred. Then 50 g of Desmodur® W and 116 g of Desmodur® I were added and the mixture was heated to 65° C. The mixture was stirred at this temperature until an NCO content of 2.7% had been attained. Subsequently, the mixture was cooled down to 60° C. and dissolved in 1122 g of acetone, and stirred for a further 5 min. Subsequently, within 2 min, a solution of 3 g of diethylenetriamine and 1 g of ethylenediamine and 2 g of butylamine and 58 g of sodium N-(2-aminoethyl)-2-aminoethanesulfonate in 93 g of water was added. On completion of addition, the mixture was stirred for a further 5 min, then 998 g of water were added within 10 min. Thereafter, the mixture was stirred at 40° C. for 20 min before the acetone was removed by distillation under reduced pressure at this temperature. For reaction of the isocyanate groups to completion, the mixture was stirred at 40° C. until no NCO was detectable any longer by IR spectroscopy. After the mixture had been cooled down to <30° C., it was filtered through a 240 μm high-speed filter from Erich Drehkopf.
Indices of the polyurethane dispersion:
Mean particle size: 99 nm
pH (10% humidity, 20° C.): 7.6
Solids content: 35%
Viscosity (D 40 S⁻¹): 1560 mPas

General Production of the Polyurethane/Polyacrylate Dispersion (PUR-PAC 1-4)

The paragraph which follows describes a general synthesis method for production of the PUR-PAC dispersions of the invention; the specific compositions and indices of the individual experiments can be taken from tab. 1.

A 3 L glass reactor with regulated heating and cooling and stirrer motor was initially charged under a nitrogen atmosphere with a mixture of 2100 g of the particular polyurethane precursor (PUR 1 to PUR 4) and 234 g of water, and initially charged with moderate stirring (laboratory 150 rpm) in an N₂-blanketed reactor and heated up to 75° C. A monomer mixture composed of 6 g of 2-ethylhexyl acrylate and 12 g of methyl methacrylate and an initiator solution composed of 0.1 g of APS and 10 g of water were metered in in parallel within 15 minutes. This was followed by a period of stirring at 75° C. for 30 min Then a monomer mixture composed of 54 g of 2-ethylhexyl acrylate and 108 g of methyl methacrylate and an initiator solution composed of 0.5 g of APS and 80 g of water were fed in in parallel within 120 minutes.

Subsequently, the reaction mixture was stirred at 75° C. for a further hour. Finally, the mixture was cooled to 25-30° C. and filtered through a 125 μm filter.

TABLE 1
Formulations for production of the PUR-PAC dispersions
PUR-PAC 1-4 (composition in % by weight and indices
of the respective dispersion).

| | PUR-PAC 1 | PUR-PAC 2 | PUR-PAC 3 | PUR-PAC 4 |
|---|---|---|---|---|
| | inventive | comparative | comparative | comparative |
| PUR 1 | 80.2% | | | |
| PUR 2 | | 80.2% | | |
| PUR 3 | | | 80.2% | |
| PUR 4 | | | | 80.2% |
| Methyl | 13.1% | 13.1% | 13.1% | 13.1% |
| methacrylate | | | | |
| Ethylhexyl | 6.6% | 6.6% | 6.6% | 6.6% |
| acrylate | | | | |
| Ammonium | 0.1% | 0.1% | 0.1% | 0.1% |
| persulfate | | | | |
| Indices: | | | | |
| Particle size | 66 | 87 | 59 | 107 |
| (nm) | | | | |
| Viscosity (D 40 | 25 | 137 | 329 | 268 |
| S−1): | | | | |
| Solids content | 35 | 35 | 35 | 35 |
| (%) | | | | |
| pH | 7.6 | 7.4 | 7.2 | 7.0 |

Production of the Polyurethane/Polyacrylate Dispersion (PUR-PAC 5, Inventive)

A 3 L glass reactor with regulated heating and cooling and stirrer motor was initially charged under a nitrogen atmosphere with a mixture of 1500 g of the polyurethane precursor PUR 1 and 256.5 g of water, and heated up to 75° C. with moderate stirring (250 rpm). A monomer mixture composed of 9 g of 2-ethylhexyl acrylate and 18.15 g of methyl methacrylate and an initiator solution composed of 0.29 g of APS and 70 g of water were metered in in parallel within 15 minutes. This was followed by a period of stirring at 75° C. for 30 min Then a monomer mixture composed of 81.9 g of 2-ethylhexyl acrylate and 163.7 g of methyl methacrylate and an initiator solution composed of 0.3 g of APS and 129 g of water were fed in in parallel within 120 minutes.

Subsequently, the reaction mixture was stirred at 75° C. for a further hour. Finally, the mixture was cooled to 25-30° C. and filtered through a 125 μm filter.

Production of a Mixture of Polyurethane and Polyacrylate Dispersion (PUR-PAC 6) (Comparative)

A 3 L glass reactor with regulated heating and cooling and stirrer motor was initially charged under a nitrogen atmosphere with a mixture of 10.4 g of Tanemul 951 and 550 g of water, and heated up to 80° C. with moderate stirring (250 rpm). A monomer mixture composed of 18 g of 2-ethylhexyl acrylate and 36.30 g of methyl methacrylate and an initiator solution composed of 0.50 g of APS and 70 g of water were metered in in parallel within 30 minutes. This was followed by a period of stirring at 80° C. for 30 min Then a monomer mixture composed of 163.80 g of 2-ethylhexyl acrylate and 327.4 g of methyl methacrylate and an initiator solution composed of 2.30 g of APS, 10.20 g of Tanemul 951 and 129 g of water were fed in in parallel within 120 minutes.

Subsequently, the reaction mixture was stirred at 80° C. for a further hour. Finally, the mixture was cooled to 25-30° C. and filtered through a 125 μm filter. 420 g of the PAC dispersion thus obtained were then mixed in a 2 L beaker with 780 g of the polyurethane precursor PUR 1 while stirring and finally filtered again through a 125 μm filter.

TABLE 2
Formulations for production of the PUR-PAC dispersions
PUR-PAC 5 and 6 (composition in % by weight and
indices of the respective dispersion).

| | PUR-PAC 5 | PUR-PAC 6 |
|---|---|---|
| | inventive | comparative |
| PUR 1 | 64.9% | 64.9% |
| Methyl | 23.3% | 23.3% |
| methacrylate | | |
| Ethylhexyl acrylate | 11.7% | 11.7% |
| Ammonium | 0.08% | 0.50% |
| persulfate | | |
| Indices: | | |
| Particle size (nm) | 87 | 100 |
| Viscosity (D 40 | 35 | 20 |
| S−1): | | |
| Solids content (%) | 35.1 | 34.3 |
| pH | 8.1 | 8.2 |

Production of the Polyurethane/Polyacrylate Dispersion (PUR-PAC 7, Inventive)

A 3 L glass reactor with regulated heating and cooling and stirrer motor was initially charged under a nitrogen atmosphere with a mixture of 1305.5 g of the polyurethane precursor PUR 1, 300 g of styrene and 472.5 g of water, and heated up to 75° C. with moderate stirring (250 rpm). This was followed by a period of stirring at 75° C. for 60 min Then an initiator solution composed of 1.5 g of APS and 80 g of water was fed in within 120 minutes.

Subsequently, the reaction mixture was stirred at 75° C. for a further hour. Finally, the mixture was cooled to 25-30° C. and filtered through a Seitz T 5500 filter.

Production of a Polyurethane/Polyacrylate Dispersion (PUR-PAC 8) with a Lyophilic Initiator (Comparative)

A 3 L glass reactor with regulated heating and cooling and stirrer motor was initially charged under a nitrogen atmosphere with a mixture of 1305.5 g of the respective polyurethane precursor PUR 1,270 g of styrene and 552.5 g of water, and heated up to 80° C. with moderate stirring (250 rpm). This was followed by a period of stirring at 80° C. for 60 min Then an initiator solution composed of 1.5 g of azoisobutyronitrile and 30 g of styrene was fed in within 120 minutes.

Subsequently, the reaction mixture was stirred at 80° C. for a further hour. Finally, the mixture was cooled to 25-30° C. and filtered through a Seitz T 5500 filter. The filtration was very difficult because of the elevated viscosity. The pour-on test of the dispersion (50 g of filtered sample +300 g of water) gave a very high level of specks (film assessment not OK).

It is thus not possible to use the dispersion PUR-PAC 8 as a paint.

TABLE 3
Formulations for production of the PUR-PAC dispersions
PUR-PAC 7 and 8 (composition in position in % by weight
and indices of the respective dispersion).

| | PUR-PAC 7 | PUR-PAC 8 |
|---|---|---|
| | inventive | comparative |
| PUR 1 | 60.11 | 60.11% |
| Styrene | 39.69 | 39.69 |
| Ammonium | 0.20% | |
| persulfate | | |
| Azoisobutyronitrile | | 0.20% |
| Indices: | | |
| Particle size (nm) | 74 | 79 |
| Viscosity (D 40 | 15 | 71 |
| S−1): | | |
| Solids content (%) | 34.8 | 34.6 |
| pH | 7.3 | 7.5 |

Formulation of the Dispersions

Pour-On Test 1 g of butyldiglycol and 2.2 g of distilled water were mixed and then 0.03 g of Byk 346 was added. Subsequently, 10 g of the appropriate PUR-PAC 1 to PUR-PAC 4 dispersion were added and the resulting mixture was stored at room temperature for about 30 minutes before the pour-on test was conducted.

TABLE 4
Formulations for production of the pour-on
film (composition in grams).

| | 1 A | | | |
|---|---|---|---|---|
| | inventive | 2 A | 3 A | 4 A |
| I.) Butyldiglycol | 1.00 | 1.00 | 1.00 | 1.00 |
| Dist. water | 2.20 | 2.20 | 2.20 | 2.20 |
| II.) BYK 346, as | 0.03 | 0.03 | 0.03 | 0.03 |
| supplied | | | | |
| III.) PUR-PAC 1 | 10.00 | | | |
| PUR-PAC 2 | | 10.00 | | |
| PUR-PAC 3 | | | 10.00 | |
| PUR-PAC 4 | | | | 10.00 |

Clearcoat Test

For the production of the test clearcoat, the components were weighed out successively and stirred together. A 5% DMEA solution was used to adjust the pH.

TABLE 5
Formulations for production of the clearcoat
film (composition in grams).

| | 1 CC | | | | 5 CC | |
|---|---|---|---|---|---|---|
| | inventive | 2 CC | 3 CC | 4 CC | inventive | 6 CC |
| PUR-PAC 1 | 13.71 | | | | | |
| PUR-PAC 2 | | 13.87 | | | | |
| PUR-PAC 3 | | | 13.79 | | | |
| PUR-PAC 4 | | | | 13.71 | | |
| PUR-PAC 5 | | | | | 13.68 | |
| PUR-PAC 6 | | | | | | 13.99 |
| Luwipal 073, as | 1.50 | 1.50 | 1.50 | 1.50 | 1.60 | 1.60 |
| supplied | | | | | | |
| BYK 346, as | 0.03 | 0.03 | 0.03 | 0.03 | 0.03 | 0.03 |
| supplied | | | | | | |
| Dist. water | 0.50 | 0.60 | 0.60 | 1.00 | | |
| DMEA, 5% in dist. | 1.00 | 0.90 | 0.80 | 0.03 | 0.80 | 0.80 |
| water (to pH | | | | | | |
| 8.0-8.5) | | | | | | |

One-Component Metallic Basecoats

For the production of the basecoat, the PUR-PAC dispersion was initially charged and mixed with a mixture of distilled water and butylglycol. A 10% DMEA solution was used to adjust the pH to 8.0-8.5. Subsequently, the mixture was stirred at about 2000 rpm (5.2 m/s) under the dissolver for 5 minutes. Then a mixture of Luwipal 073, butylglycol and distilled water was added and the mixture was stirred again at about 2000 rpm (5.2 m/s) under the dissolver for 5 minutes. Then the prepared metallic paste (tab. 5) was added, which was incorporated at about 4000 rpm (10.5 m/s) under the dissolver for 30 minutes. Subsequently, Aquatix 8421 and distilled water are incorporated at about 2000 rpm (5.2 m/s) under the dissolver for 5 minutes and then the mixture is adjusted to spray viscosity (flow time 40 s in DIN cup, 4 mm nozzle) with distilled water.

TABLE 6
Formulations for production of the basecoat
film (composition in grams).

| | 5 M | | | |
|---|---|---|---|---|
| | inventive | 6 M | 7 M | 8 M |
| I. PUR-PAC 1 | 153.74 | | | |
| PUR-PAC 2 | | 155.51 | | |
| PUR-PAC 3 | | | 154.62 | |
| PUR-PAC 3 | | | | 153.74 |
| II. Dist. water | 12.50 | 22.50 | 22.50 | 22.50 |
| Butylglycol | 14.73 | 14.73 | 14.73 | 14.73 |
| DMEA, 10% in dist. water | 16.40 | 15.00 | 15.00 | 8.20 |
| (to pH 8.0-8.5) | | | | |

- stir at about 2000 rpm (5.2 m/s) for 5 min -

| | | | | |
|---|---|---|---|---|
| III. Luwipal 073, as supplied | 16.82 | 16.82 | 16.82 | 16.82 |
| Butylglycol | 14.73 | 14.73 | 14.73 | 14.73 |
| Dist. water | 12.50 | 22.50 | 22.50 | 50.00 |

- stir at about 2000 rpm (5.2 m/s) for 5 min -

| | | | | |
|---|---|---|---|---|
| IV. Metallic paste (see table 5) | 52.91 | 52.91 | 52.91 | 52.91 |

- stir at about 4000 rpm (10.5 m/s) for 30 min -

| | | | | |
|---|---|---|---|---|
| V. Aquatix 8421, as supplied | 18.83 | 18.83 | 18.83 | 18.83 |
| dist. Water | 32.50 | 32.50 | 32.50 | 70.00 |

- stir at about 2000 rpm (5.2 m/s) for 5 min -

| | | | | |
|---|---|---|---|---|
| VI. Dist. water (to flow time | 26.00 | 32.40 | 29.90 | 58.40 |
| 40 s in DIN cup, 4 mm) | | | | |
| Total weight | 371.66 | 398.43 | 395.04 | 480.86 |

Metallic Paste

The components were weighed out successively and premixed under a propeller stirrer. The pH was to be pH 8.0-8.5 and, if necessary, was adjusted with DMEA. Then the paste was mixed under the propeller stirrer at 10.5 m/s for 30 minutes, such that the temperature as far as possible did not exceed 50° C. here.

TABLE 7
Formulation for production of the metallic
paste (composition in grams).

| | | |
|---|---|---|
| I | Butylglycol | 41.88 |
| II | Setaqua D E 270, as supplied | 2.89 |
| III | Additol XL 250, as supplied | 4.36 |
| IV | Stapa Hydrolan 2156 Nr. 55900/G Aluminium, as | 50.64 |
| | supplied | |
| V | Dimethylethanolamine, as supplied | 0.23 |
| | | 100.00 |

Results

Assessment of the Paint Film

The advantages of the polyurethane/polyacrylate dispersions PUR-PAC 1 and PUR-PAC 5 are apparent from the results of the paint testing summarized in table 8. In the case of the PUR-PAC dispersion 1, what should be emphasized here is in particular the improved hiding power compared to the dispersions made from comparative examples PUR-PAC 2-4. The inventive polyurethane/polyacrylate dispersion PUR-PAC 5 has a much better film appearance and solvent resistance compared to the noninventive polyurethane/polyacrylate dispersion PUR-PAC 6. Furthermore, the thermal yellowing of PUR-PAC 5 is also much lower than the thermal yellowing of the noninventive polyurethane/polyacrylate dispersion PUR-PAC 6.

TABLE 8
Properties of the paint film.

| | PUR-PAC 1 | PUR-PAC 2 | PUR-PAC 3 | PUR-PAC 4 | PUR-PAC 5 | PUR-PAC 6 |
|---|---|---|---|---|---|---|
| | inventive | comparative | comparative | comparative | inventive | comparative |
| Pour-on test (film assessment, visual) | | | | | | |
| Turbidity | none | none | none | none | | |
| Specks | m 3, g 1 | m 4-5, g 1 | m 3-4, g 1 | m 1-2, g 1 | | |
| Craters | m 0, g 0 | m 0, g 0 | m 0, g 0 | m 0, g 0 | | |
| Cracking | none | none | none | none | | |
| Clearcoat | | | | | | |
| Compatibility in the paint | OK | OK | OK | Sediment | OK | Sediment |
| (visual assessment) | | | | Incompatibility | | |
| Baking conditions for clearcoat: 20 minutes at 140° C. | | | | | | |
| Film assessment | | | | | | |
| Turbidity | none | none | none | high turbidity | none | medium turbidity |
| Specks | m 3-4, g 1 | m 5, g 1 | m 5, g 1 | m 5, g 1 | m 3-4, g 1 | m 5, g 1 |
| Craters | m 0, g 0 | m 0, g 0 | m 0, g 0 | m 0, g 0 | m 0, g 0 | m 0, g 0 |
| Cracking | none | none | none | none | none | none |
| Pendulum damping [s] | 77 | 65 | 67 | 43 | 82 | 103 |
| Solvent resistance, 1 min. | 2/2/2/4 | 2/2/2/4 | 2/2/2/4 | 4/3/5/5 | 2/2/2/4 | 3/3/2/4 |
| (Xl/MPA/EA/acetone) | | | | | | |
| Yellowing after 30′ at 180° C. | | | | | 1.04 | 5.38 |
| Δb* (D65 10° d/8°) | | | | | | |

Metallic basecoat

| | | PUR-PAC 1 | PUR-PAC 2 | PUR-PAC 3 | PUR-PAC 4 |
|---|---|---|---|---|---|
| | | inventive | comparative | comparative | comparative |
| Solids content (theo.) at spray | | 24.1 | 22.4 | 22.6 | 18.6 |
| viscosity [% by wt.] | | | | | |
| Appearance | | slight | slight | slight | slight floating of |
| | | floating of | floating of | floating of | pigments, some |
| | | pigments | pigments | pigments | edge contraction |
| Flip Flop | | L. | L. | L. | L. |
| (D 65/10°) | 15° | 143.03 | 143.44 | 142.52 | 143.98 |
| | 25° | 109.22 | 107.70 | 108.39 | 107.58 |
| | 45° | 59.32 | 57.37 | 58.71 | 57.08 |
| | 75° | 34.25 | 33.79 | 34.36 | 34.74 |
| | 110° | 29.08 | 28.90 | 29.14 | 30.37 |
| | 25°/75° | 74.97 | 73.91 | 74.03 | 72.84 |
| | 15°/110° | 113.95 | 114.54 | 113.38 | 113.61 |

| | | | | |
|---|---|---|---|---|
| OEM paint setup (cathodic | 32/30/11/36 | 30/30/11/34 | 31/31/12/30 | 31/29/13/30 |
| electrocoat/surfacer/wbc/ | | | | |
| cc) in μm | | | | |
| Hiding power (50 μm wet | OK | partly OK | partly OK | not OK |
| film) | | | | |

Testing of Ring Line Stability

The ring line stability of the aqueous polyurethane/polyacrylate dispersions was simulated by means of a Göttfert capillary rheometer. For this purpose, 500 g of the appropriate dispersion PUR-PAC 1 to PUR-PAC 4 were introduced into the vessel and forced through an annular gap of size 20 μm at constant speed by means of a movable cylinder. If the material is shear-stable, it can be forced through the annular gap without pressure buildup. In the case of shear-unstable material, the dispersion coagulates and blocks the nozzle, and a pressure buildup is recorded. The shear forces simulated here can be calculated with reference to the gap size and the speed, and in the present case were 375 000 l/s.

The results of the measurement of ring line stability are shown in FIG. 1. It is apparent from the graphs that it was possible to distinctly improve the shear stability by means of the inventive polyurethane/polyacrylate dispersion PUR-PAC 1, since the pressure rose only slightly, whereas the pressure in testing of the dispersions produced as comparative examples (PUR-PAC 2 to 4) rose much more significantly and to higher pressures.

1.-16. (canceled)

17. An aqueous dispersion comprising component A) an ethylenically unsaturated compound, and component B) a polyurethane resin reacted from components comprising:
I) at least one aliphatic, cycloaliphatic, araliphatic and/or aromatic compound having at least two or more isocyanate groups,
II) at least one polycarbonate polyol having a mean molecular weight of 500 to 3000 g/mol,
III) at least one anionically hydrophilizing compound which has at least one OH- or NH-functional group and comprises a carboxyl and/or carboxylate group,
IV) at least one polyol or polyamine having a mean molecular weight between 62 g/mol and 500 g/mol, and
V) optionally, at least one or more monoalcohols and/or monoamines,
wherein a hydrophilic initiator is used as initiator of the free-radical polymerization.

18. The aqueous dispersion of claim 17, wherein component A) is 3% to 40% by weight, and component B) is 97% to 60% by weight, based on the total weight of the dispersion.

19. The aqueous dispersion of claim 17, wherein the hydrophilic initiator comprises one or more persulfate compounds.

20. The aqueous dispersion of claim 19, wherein the hydrophilic initiator comprises ammonium peroxodisulfate, sodium peroxodisulfate or potassium peroxodisulfate.

21. The aqueous dispersion of claim 17, wherein component A) comprises at least one aliphatic, cycloaliphatic or aromatic acrylate or methacrylate.

22. The aqueous dispersion of claim 21, wherein component A) comprises an alkyl-substituted acrylate or an alkyl-substituted methacrylate.

23. The aqueous dispersion of claim 17, wherein component I) comprises an aliphatic, cycloaliphatic, araliphatic or aromatic diisocyanate.

24. The aqueous dispersion of claim 23, wherein component I) comprises 1,6-diisocyanatohexane, 1-isocyanato-3,3,5-trimethyl-5-isocyanatomethylcyclohexane or 4,4′-diisocyanatodicyclohexylmethane.

25. The aqueous dispersion of claim 17, wherein the polycarbonate polyol has a mean molecular weight of 1000 to 3000 g/mol.

26. The aqueous dispersion of claim 25, wherein the polycarbonate polyol has a mean molecular weight of 1250 to 2500 g/mol.

27. The aqueous dispersion of claim 26, wherein the polycarbonate polyol has a mean molecular weight of 1500 to 2100 g/mol.

28. The aqueous dispersion of claim 17, wherein the anionically hydrophilizing compound is free of sulfonic acid groups and sulfonate groups.

29. The aqueous dispersion of claim 17, wherein the anionically hydrophilizing compound comprises dimethylolpropionic acid, dimethylolpropionate, N-(2-aminoethyl)-2-aminoethanecarboxylic acid or N-(2-aminoethyl)-2-aminoethanoate.

30. The aqueous dispersion of claim 17, wherein the components are used in the following amounts:
10% to 45% by weight of component I);
45% to 75% by weight, of component II);
0.1% to 15% by weight, of component III);
0.1% to 5% by weight, of component IV); and
0% to 5% by weight, of component V),
based on the weight of the polyurethane resin.

31. The aqueous dispersion of claim 17, wherein component B) further comprises a polyester polyol or a polyether polyol.

32. A coating composition comprising an aqueous dispersion of claim 17 and at least one crosslinking agent.

33. A composite material comprising a coating composition of claim 32 and a substrate having a surface of metal or plastic.

34. A process for producing component A) an ethylenically unsaturated compound, by free-radical polymerization,
in the presence of a hydrophilic initiator, and
further in the presence of component B) a polyurethane resin comprising:
I) at least one aliphatic, cycloaliphatic, araliphatic and/or aromatic compound having at least two or more isocyanate groups,
II) at least one polycarbonate polyol having a mean molecular weight of 500 to 3000 g/mol,
III) at least one anionically hydrophilizing compound which has at least one OH- or NH-functional group and comprises a carboxyl and/or carboxylate group,
IV) at least one polyol or polyamine having a mean molecular weight between 62 g/mol and 500 g/mol, and
V) optionally, at least one or more monoalcohols and/or monoamines

35. The process of claim 34, in which component B) is initially charged and the free-radical polymerization is conducted by continuous metered addition of component A) in the presence of the hydrophilic initiator.

36. The process of claim 35, in which component B) is initially charged and the free-radical polymerization is conducted by continuous metered addition of both component A) and the hydrophilic initiator into the initial charge of component B), in parallel.
